(19) United States
(12) Patent Application Publication
(10) Pub. No.: US 2018/0322197 A1
(43) Pub. Date: Nov. 8, 2018

(54) VIDEO DATA CREATION AND MANAGEMENT SYSTEM

(71) Applicant: Survae Inc., Wilmington, NC (US)

(72) Inventor: Eric Scott HESTERMAN, Westminster, MD (US)

(21) Appl. No.: 15/970,532

(22) Filed: May 3, 2018

Related U.S. Application Data
(60) Provisional application No. 62/501,028, filed on May 3, 2017.
(60) Provisional application No. 62/554,719, filed on Sep. 6, 2017.
(60) Provisional application No. 62/554,729, filed on Sep. 6, 2017.
(60) Provisional application No. 62/640,104, filed on Mar. 8, 2018.

(51) Int. Cl. G06F 17/30; H04Q 9/02

(52) U.S. Cl. CPC G06F 17/30817; H04Q 9/02; G06F 17/30823; G06F 17/30241

(57) ABSTRACT

A method includes maintaining a representation of a spatial region, maintaining a plurality of trajectory records, each trajectory record comprising a sequence of time points and corresponding spatial coordinates, maintaining, for each trajectory record of the plurality of trajectory records, sensor data, the sensor data being synchronized to the sequence of time points and corresponding spatial coordinates, presenting a portion of the representation of the spatial region including presenting a representation of multiple trajectory records of the plurality of trajectory records, each trajectory record of the multiple trajectory records having at least some spatial coordinates located in the portion of the spatial region.

### CROSS-REFERENCE TO RELATED APPLICATIONS

This application claims the benefit of U.S. Provisional Application No. 62/501,028, filed May 3, 2017 and titled “Searching and Linking Videos Through Data,” U.S. Provisional Application No. 62/554,719, filed Sep. 6, 2017 and titled “Cataloging, Indexing, and Searching Content with Geospatial Data,” U.S. Provisional Application No. 62/554,729, filed Sep. 6, 2017 and titled “Creating Content with Geospatial Data,” and U.S. Provisional Application No. 62/640,104, filed Mar. 8, 2018 and titled “Live Video Capture and Interface,” the contents of which are incorporated herein in their entirety.

### BACKGROUND

This invention relates to video data creation and management.

Traditional ways of searching for videos may be performed by way of a video search engine, which may be a web-based search engine that queries the web for video content. In general, traditional video searches may often be performed on titles, descriptions, tag words, and upload dates of the video. The searches performed by searching in this manner may only be as good as the search terms used. That is, it may be very difficult to almost impossible to find a place or event with a video because there is little or no data in or linked to most videos.

Some ways of searching for videos facilitate a location-based search. For example, some existing location-based search engines use a single position coordinate to put a marker on a map representing the start of a video. Furthermore, some traditional map-based searches look for data containing coordinates that are within the visible map boundaries. While this can be beneficial to some extent, in cases where a recording does not remain in one location, those searches may return inaccurate results due to missing data from everything after the starting point of the video.

In some examples, videos are generated by videographers or unmanned aerial vehicles (UAVs). Generally, a videographer or UAV pilot interprets written, verbal or visual instructions, often in the form of maps, during planning or when recording video. The interpretation may lead to a close approximation of the requested imagery or video footage, but there exists a margin for error.

Videos generated by videographers (e.g., using a smartphone camera or a global positioning system (GPS)-enabled camera) or UAVs may include rich metadata including time and location information. Typically, for videos captured by a mobile device, location data for the video may be confined to a single set of coordinates originating from the starting point of the videos. Some videos generated by cameras and UAVs include metadata including but not limited to location, orientation, compass heading, and other data captured at short intervals for the duration of the video recording.

### SUMMARY

There is yet to be provided a viable way to catalog, index, and search videos with rich metadata. There is a need therefore for addressing the drawbacks associated with traditional techniques for cataloging, indexing, searching, and linking video content. There is also a need for developing more efficient and advantageous ways of finding video footage, and creating data, video, or image collection missions with geospatial data. There is a further need to provide a way of connecting separate videos with each other, and to make such connected videos searchable.

In one general aspect, a search method uses geospatial data to catalog, index and search for video, imagery and data. For example, geospatial data is typically stored in databases or in a variety of file formats. This data may include, but is not limited to, geometries, information about the geometry in whole or in part, URL or other links to additional data, projections, imagery, video, notes and comments. The geometric data includes of, but is not limited to, polygons, curves, circles, lines, polylines, points, position, orientation, additional dimensions like altitude, latitude and longitude or other coordinate systems, reference points and styling information. These data sets may be sourced by our service, provided by a third party, uploaded by the user or created on our service and may be in database, file or data stream form, in whole or in part.

Geospatial data may be represented as, or used for and is not limited to, the creation of a map or part thereof, map layer, imagery or video layer, set of instructions or directions, planning and/or guiding automated or manned ground, subterranean, marine, submarine, aerial or space travel or database search. In additional to numeric, time, text and other traditional searches, geometric queries may be performed on spatial databases to find results that may include, but are not limited to, overlapping, adjacent, intersecting, within or outside of some bounds, changes in size, position or orientation or shape type. Additional query conditions may apply, adding to or filtering the data sets.

Video metadata may include time and location. Typically, for videos captured by a smartphone or GPS-enabled camera, location is confined to single set of coordinates for the starting point of a video. Some newer camera and UAV videos include location, orientation, compass heading and other data, captured at short intervals, for the duration of the video recording.

Existing location-based search use a single position coordinate to put a marker on a map, representing the start of a video. Traditional map searches look for data containing coordinates that are within the visible map boundaries. While this can be beneficial to some extent, in cases where a recording does not remain in one location, the search will return inaccurate results, due to missing data from everything after the starting point of the video. Our invention displays each search result as a two or three-dimensional polyline, representing one or more videos and or data. These videos and/or data may be recorded in multiple wavelengths and/or fields of view.

Aspects described herein uses metadata recorded throughout the duration of the video. Map-based search now finds results for any part of a video, represented by some metadata coordinates that are within the map view. Visible map boundaries include a box including east and west longitudes and north and south latitudes. This bounding box may be used to find overlapping video metadata paths. Video metadata paths, represented as geometric data, may be used to find other geometries by finding overlaps, intersections, proximity, data inside of, or outside of, statistical and other algorithm limitations, calculated, observed or stored dynamic objects such as moving shapes where time and position for both the video metadata and the object may be used with one of the aforementioned conditions.

The reverse may also be true where videos, imagery and data may be found by selecting and running the same conditions on static or dynamic geospatial data, in numeric, text, vector, raster or any other form. Additional search conditions may be applied, expanding or reducing the dataset. Altitude, time, speed, duration, orientation, g-forces and other sensor data, machine vision, artificial intelligence or joined database queries and other conditions may be used.

Further, video or objects such as, but not limited to, land, waterways, bodies of water, buildings, regions, boundaries, towers, bridges, roads and their parts, railroad and their subparts and infrastructure may be found using projected, i.e. calculated, field of view or some part thereof. Further, individual video frames or sections of video may be found by defining some area or selecting some geospatial obj ect(s), or part of an object, or referencing one or more pieces of data related to one or more objects that contain or are linked to geospatial data. They may be, but are not limited to be, represented as a mark or marks on a map or map layer, video's camera path polyline, or camera's calculated field of view, represented as polylines or polygons, all of which may be represented in two dimensions or three.

Further, related videos may be found by searching for conditions where one video's camera route or view area intersects with another ‘s. This intersection may be conditioned upon time and/or location of a static geospatial object or may be of the same object at two different places and times. An example would be of an event like a tsunami or a storm where the object moves and there may be videos taken of that moving object from different places and vantage points at different times, all found through their relationship with that object, irrespective of position or time. Conditions may be set, depending on the desired results. An example would be where videos recorded of an intersecting region, at the same time, from different vantage points, may be used to derive multidimensional data. Further, statistical modeling of static or dynamic geometric data may be used to generate a video job or a condition on a query. An example would be, but is not limited to, a third-party data source, such as Twitter being used to flag an area of density, indicating some unusual event that warrants a video recording or search. This type of geometric data may be derived from, but is not limited to, the internet of things (IOT), mobile phone location data, vehicle data, population counts, animal and other tracking devices and satellite data and/or imagery derived points of interest.

Videos and geospatial objects may be indexed to enable rapid search. Cataloging organizes this data so that future, non-indexed searches may be performed and allows dynamic collections to be built. These collections have some user or platform defined relationships. The video collections may be built by finding related geospatial object types including, but not limited to, region, similar or dissimilar motions, speeds and locations. These saved collections may be added to by the user or automatically by the platform.

Examples include, but are not limited to all videos, video frames, imagery and/or recorded metadata that include data that is over 1000 miles per hour and over 40,000 feet and sort by highest g-forces, first); all videos, video frames, imagery and/or recorded metadata that include the selected pipeline; all videos, video frames, imagery and/or recorded metadata that include some part number associated with an object; all videos, video frames, imagery and/or recorded metadata that include some geometric or volumetric geospatial change, within the same video, or compared to other videos or imagery; all videos, video frames, imagery and/or recorded metadata that include an intersection with a tracking device; all videos, video frames, imagery and/or recorded metadata that include an intersection with a group of people moving at over 4 miles per hour.

In a general aspect, a method includes maintaining a representation of a spatial region, maintaining a plurality of trajectory records, each trajectory record comprising a sequence of time points and corresponding spatial coordinates, maintaining, for each trajectory record of the plurality of trajectory records, sensor data, the sensor data being synchronized to the sequence of time points and corresponding spatial coordinates, presenting a portion of the representation of the spatial region including presenting a representation of multiple trajectory records of the plurality of trajectory records, each trajectory record of the multiple trajectory records having at least some spatial coordinates located in the portion of the spatial region.

Aspects may include one or more of the following features.

The method may include determining the multiple trajectory records based on a query. The query may include one or both of spatial query parameters and temporal query parameters. The query may include sensor data query parameters. The query may include a specification of a second sequence of time points and corresponding spatial coordinates, and the multiple trajectory records intersect with the second sequence of time points and corresponding spatial coordinates. Intersecting with the second sequence of time points and corresponding spatial coordinates may include collecting sensor data related to the second sequence of time points and corresponding spatial coordinates.

The method may include receiving a selection of a part of a first line representing the specification of the second sequence of time points and corresponding spatial coordinates and, the part of the first line corresponding to a first time point in the second sequence of time points and corresponding spatial coordinates, the selection causing presentations representations of the sensor data corresponding to the first time point from the multiple trajectory records. The method may include receiving an input causing the selection of the part of the first line to move along the first line, the moving causing sequential presentation of the representations of the sensor data corresponding to a number of time points adjacent to the first time point in the sequence of time points of the multiple trajectory records.

The query may constrain the multiple trajectory records to trajectory records of the plurality of trajectory records that include spatial coordinates that traverse a first portion of the spatial region. The first portion of the spatial region may equivalent to the presented portion of the representation of the spatial region. The first portion of the spatial region may be a spatial region inside of the presented portion of the representation of the spatial region. For each of the multiple trajectory records, the representation of the trajectory record may include a line tracing a route defined by the trajectory record. The line may include a polyline.

The method may include receiving a selection of a part of a first line representing a first trajectory record of the multiple trajectory records, the part of the first line corresponding to a first time point in the sequence of time points and corresponding spatial coordinates of the first trajectory, the selection causing presentation of a representation of the sensor data corresponding to the first time point. The selection may cause presentation of a representation of sensor data corresponding to the first time point of a second trajectory record of the multiple trajectory records.

The method may include receiving an input causing the selection of the part of the first line to move along the first line, the moving causing sequential presentation of representations of the sensor data corresponding to a number of time points adjacent to the first time point in the sequence of time points and corresponding spatial coordinates of the first trajectory record. The moving may further cause sequential presentation of representations of sensor data corresponding to a number of time points adjacent to the first time point in a sequence of times points and corresponding spatial coordinates of a second trajectory record of the multiple trajectory records.

The spatial coordinates may include geospatial coordinates. The spatial coordinates may include three-dimensional coordinates. The sensor data may include camera data. The sensor data may include telemetry data. The telemetry data may include one or more of temperature data, pressure data, acoustic data, velocity data, acceleration data, fuel reserve data, battery reserve data, altitude data, heading data, orientation data, force data, acceleration data, sensor orientation data, field of view data, zoom data, sensor type data, exposure data, date and time data, electromagnetic data, chemical detection data, and signal strength data.

The method may include receiving a selection of a representation of a first trajectory record of the multiple trajectory records and, based on the selection, presenting a trajectory record viewer including presenting a sensor data display region in the trajectory record viewer for viewing the sensor data according to the sequence of time points of the first trajectory record, the sensor display region including a first control for scrubbing through the sensor data according to the time points of the first trajectory record, and presenting spatial trajectory display region in the trajectory record viewer for viewing the representation of the first trajectory record in a second portion of the representation of the spatial region, the spatial trajectory display region including a second control for scrubbing through the time points of the first trajectory record according to the spatial coordinates of the first trajectory record.

Movement of the first control to a first time point and corresponding first sensor data point of the first trajectory record may cause movement of the second control to the first time point and corresponding first spatial coordinate of the first trajectory record, and movement of the second control to a second spatial coordinate and corresponding second time point of the first trajectory record may cause movement of the first control to the second time point and corresponding second sensor data point of the first trajectory record. The sensor data of the first trajectory record may include video data and the sensor display region in the trajectory viewer may include a video player. The method may include presenting a second sensor data display region in the trajectory record viewer for viewing sensor data according to a sequence of time points of a second trajectory record, the second sensor display region including a third control for scrubbing through the sensor data according to the time points of the second trajectory record, wherein scrubbing the third control causes a corresponding scrubbing of the first control.

In another general aspect, a video capture and interface system may include an interface system configured to receive information acquired from a moving vehicle, including receiving a plurality of parts of the information with corresponding different delays relative to the time of acquisition at the vehicle. The interface system includes a presentation subsystem for displaying or providing access to the parts of the information as they become available in conjunction with a display of a trajectory of the vehicle.

In another general aspect, a video capture and interface system comprising an interface system configured to receive information acquired from a moving vehicle, including receiving a plurality of parts of the information with corresponding different delays relative to the time of acquisition at the vehicle. The interface system includes a presentation subsystem for displaying or providing access to the parts of the information as they become available in conjunction with a display of a trajectory of the vehicle.

In some aspects, systems are configured for synchronized scrubbing and selection between map polylines. This may apply between multiple polylines on the same map and/or between polylines that are logically connected together. For example, scrubbing along one video's polyline causes a marker to indicate a corresponding time point on another video's polyline if the other video's polyline contains corresponding time. This can be used to keep track of the relationship between multiple cameras during an event.

In another example, a polyline associated with a tornado's trajectory can be scrubbed, and each related video polyline contains the corresponding marker, indicating the camera(s)’ location(s) when the tornado was there.

In another example, two or more video players are open. Scrubbing one video player's timeline or related mapped polyline will simultaneously cause the other open video player(s)' corresponding preview markers (timeline and spatial) to remain synchronized. The video players may be collocated (i.e., visible by the same person), or may be distributed (i.e., the same event is being viewed from different locations). This can help users who are communicating to know what the other is talking about or looking at.

Such configurations apply to time synced videos and to geospatially synched videos. For example, the videos may have occurred at the same time but from different perspectives. Scrubbing the timeline of one, synchronizes by time, the other. Alternatively, two identical videos, captured at different times (i.e., automated UAV flight, one month apart), are displayed next to each other. Scrubbing the Timeline or spatial polyline will pass coordinates (not time) to the other player. That player will provide a preview of the same location, irrespective of time differences.

In another aspect, in general, a video capture and interface system provides a way of acquiring information including multimedia (e.g., audio, video and/or remote sensing data) as well as associated telemetry (e.g., location, orientation, camera and/or sensor configuration), and presenting the information on an interface that provides a user the ability to access the data as it becomes available. For example, the information may be acquired from an autonomous or directed vehicle (e.g., an aerial drone), and presented to a user at a fixed location. Different parts of the information may be made available via different data and/or processing paths. For example, the telemetry may arrive over a first data network path directly from a vehicle, while the multimedia may next arrive (i.e., with a second delay) in an unprocessed form over a second path and made available in the interface in that form (e.g., as a live display), and then be available in a processed form (e.g., with multimedia in a compressed form, possibly with further processing such as segmentation, object identification, etc.) and with the processed form being displayed and/or made available via the interface. Note that when different parts of the information arrive over different paths, the interface system synchronizes the parts, for example, based on time stamps or other metadata, or optionally based on content of the multimedia (e.g., synchronizing different views of a same object).

There is a need to provide this live information as it becomes available rather than waiting until all forms of the information are available (e.g., at the worst-case delay). For example, a user may be able to react to telemetry data without requiring the multimedia, for example, to cause the vehicle to modify its path. The user may be able to react to the live display without having to wait for the multimedia to be compressed or otherwise processed. And finally, the user benefits from being able to access the compressed and/or processed multimedia when it is available.

Other features and advantages of the invention are apparent from the following description, and from the claims.

### DESCRIPTION OF DRAWINGS

FIG. 1 illustrates an exemplary map view of a polyline path of a recorded video in some examples.

FIG. 2 illustrates an exemplary map view of a polyline path of a recorded video and a preview window shown at a specific point along the polyline path in some examples.

FIG. 3A illustrates an exemplary satellite view and a camera view corresponding to a particular polyline path of a recorded video in some examples.

FIG. 3B illustrates another exemplary satellite view and a camera view corresponding to a particular polyline path of a recorded video, including a preview window in some examples

FIG. 4 illustrates an exemplary flow diagram in some examples.

FIG. 5 illustrates another exemplary flow diagram in some examples.

FIG. 6 illustrates an exemplary view of various sets of video collections and a map view corresponding to different video collections in some examples.

FIG. 7 is a live video capture and interface system showing a trajectory.

FIG. 8 is a graphical annotation of the trajectory of FIG. 7.

FIG. 9 illustrates an exemplary system in some examples.

### DESCRIPTION

### 1 Map-Based Search Engine

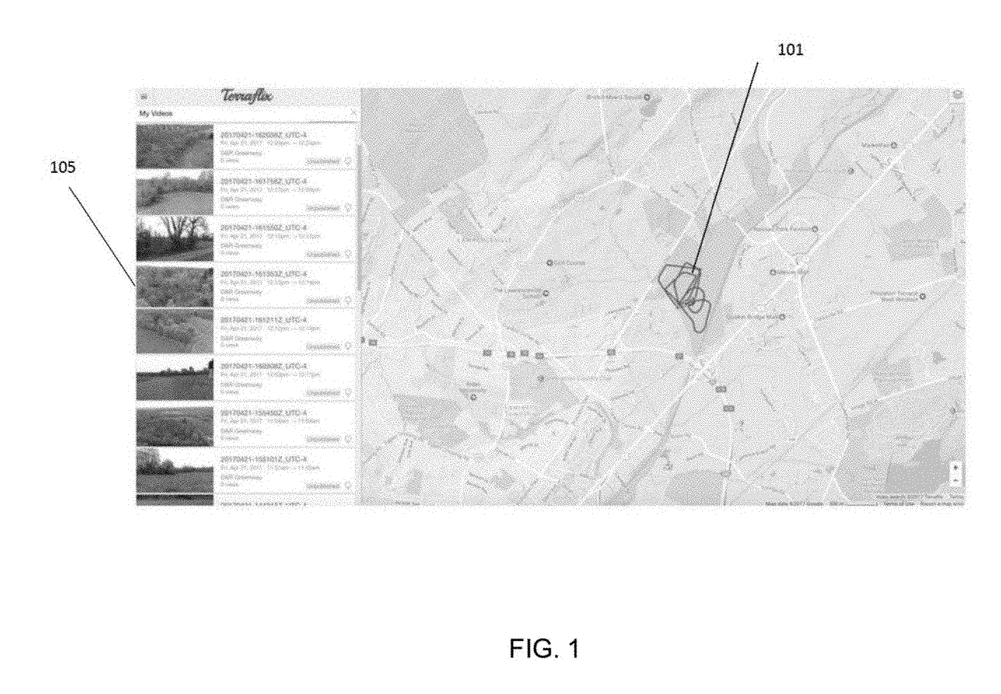

Referring to FIG. 1, a map-based search includes map view including a polyline path 101. The polyline path is associated with a trajectory record. In some examples, a trajectory record includes sensor data (e.g., a video, one or more images, telemetry data) and metadata including, among other attributes, trajectory data (e.g., a sequence of location data potions such as GPS coordinates associated with times). The search engine stores and indexes trajectory records and facilitates querying based on any combination of parameters associated with the trajectory records. When reference is made to searching for a video, a location, or any other parameter or combination of parameters, it should be apparent that the results returned by the search are associated with trajectory records, though the search results may represent the trajectory records using their sensor data (e.g., the search may return results as a list of videos) or any other metadata attributes.

The polyline path 101 is a representation of a trajectory (of a corresponding trajectory record) traversed by a videographer or UAV while recording a video. The right side of FIG. 1 includes a map of a particular area of interest, including the polyline path 101 of the recorded video. The left side of FIG. 1 includes a list of other videos 105 (each associated with a different trajectory record) that have been recorded and uploaded to a database, after which a corresponding polyline path for each video at a particular location may be automatically generated based on the trajectory data included in the trajectory record corresponding to the video. Recorded videos may be shown on a map of the pertinent location. In other embodiments, the list of videos shown on the left of FIG. 1 may represent a search result of videos that a user has searched for based on certain parameters or filters set by the user. In such examples, and as is described in greater detail below, a different polyline path is shown on the map for each of the videos in the list of other videos 105.

The map-based search may, in some examples, be performed by using a text-based search that works in tandem with a map to find videos. In some examples, each video result is displayed as a polyline path drawn on a map or virtual three-dimensional (3D) world. In some examples, each polyline path also represents a trajectory or route taken by the video recording device (e.g., a camera mounted to a UAV or a camera of a mobile device such as a smartphone) that recorded the video.

In some examples, the boundary of the map in the map-based search is used to constrain the search results to those that at least partially exist within the boundary. In some examples, text and filter searches are performed. The text and filter searches may drive the results, which may then be displayed on a world map, irrespective of location. In other words, search results may be confined to a map containing an area of user defined locations, or the results may be more expansive in that they may be displayed with respect to a worldwide map, irrespective of the visible map boundaries.

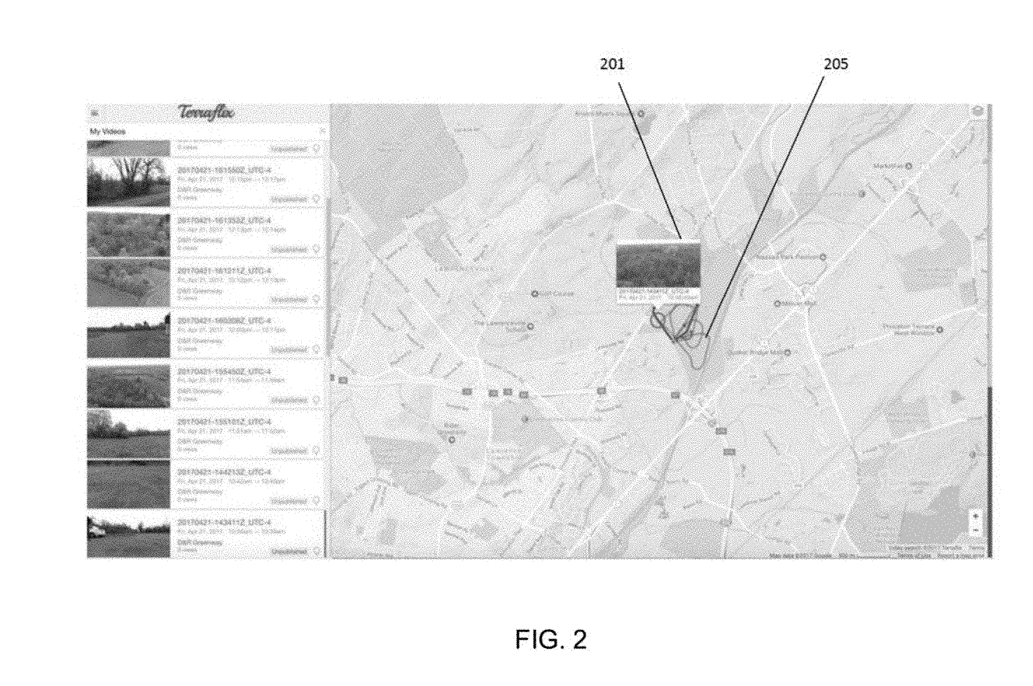

Referring to FIG. 2 a map view includes a polyline path 205 representing a recorded video and a preview window 201 associated with the polyline path 205 and shown at a specific point along the polyline path 205. The preview window 201 provides the ability to browse along a trajectory of a recorded video via the preview window 201, wherein each frame of the preview window 201 may include identifying information (e.g., sensor data from the trajectory record) corresponding to that particular point in time shown in the frame. For example, in the trajectory record for the recorded video, each frame may be associated with or have embedded therein, position information of the device recording the video, a date and time or time stamp associated with each frame, and location information of where each frame was recorded. The location information, in some examples, may include coordinate information, such as, for example, longitude and latitude coordinates. Thus, with such information, it may be possible during video analysis, to identify what is shown in the video at a particular location and a particular point in time.

In some examples, a video path preview may be implemented on an electronic device, such as a computer described above, or any one of the other devices described above. For instance, a user of the device that is implementing the video path preview can, via an interactive user interface, touch and drag (i.e., scrub) a finger along, or hover a cursor over a mapped video path shown on a display of an electronic computing device, which may then cause the device to display the camera view for that geographic location of the video recording device. As the cursor or finger is moved, a preview box may follow with the appropriate preview for that specific location, referred to as scrubbing.

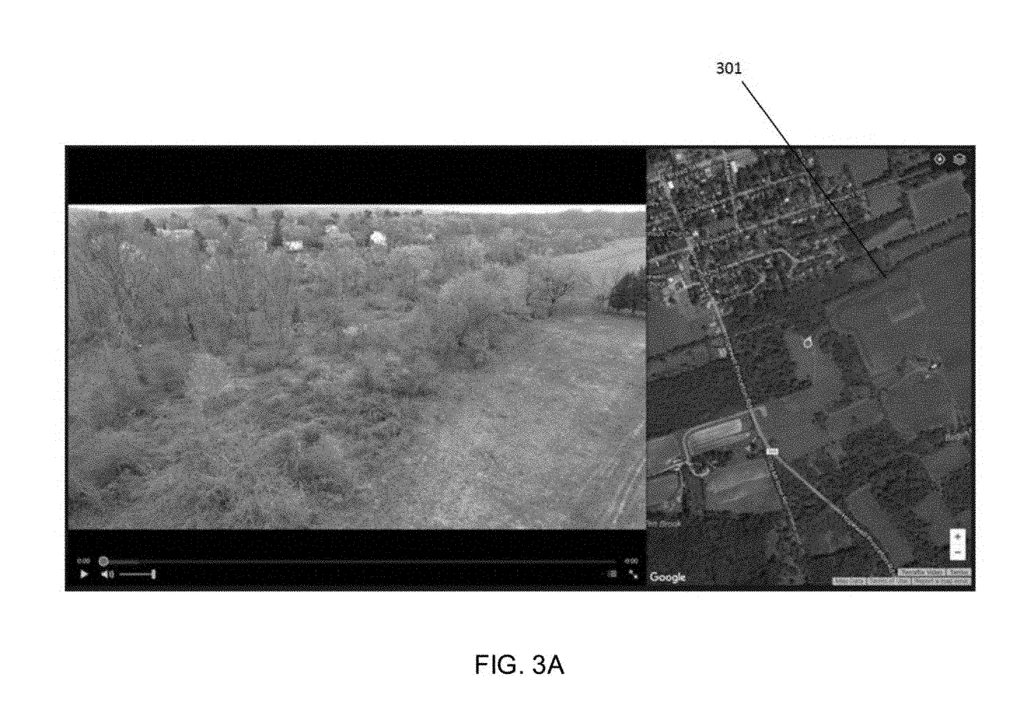

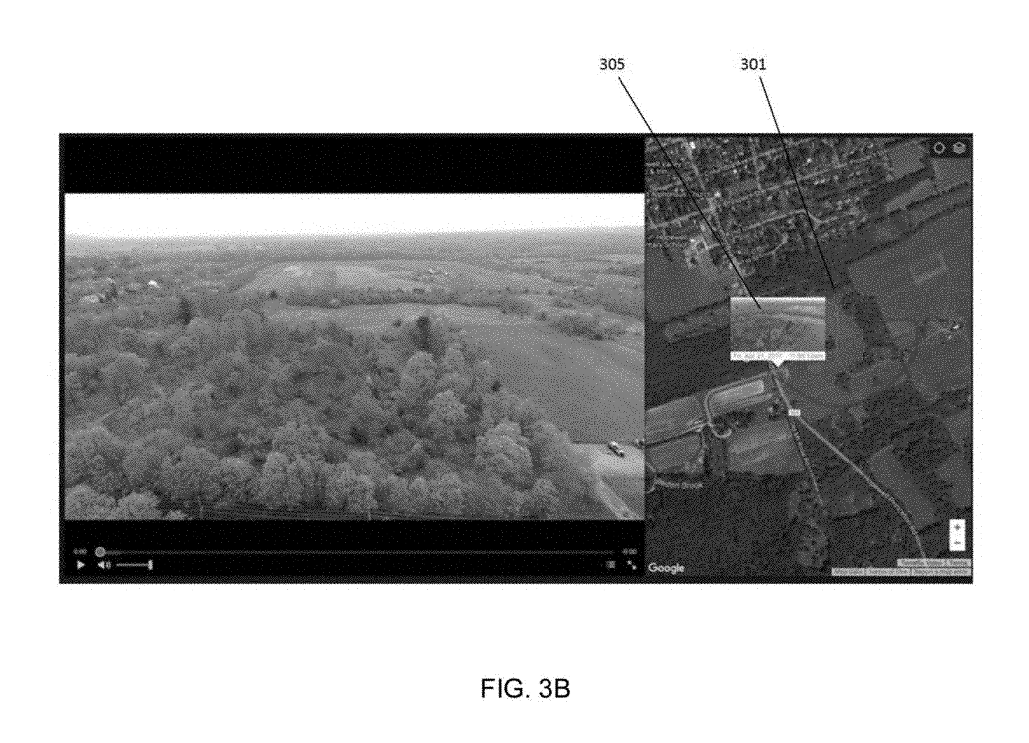

Referring to FIGS. 3(A) and 3(B) exemplary satellite views and camera views for a particular polyline path of a recorded video are shown. In some examples, FIGS. 3(A) and 3(B) include satellite imagery, maps, or a hybrid of both. Further, in some examples, maps may include topographical, aviation, nautical, or other specialized charts.

Referring to FIG. 3(A), on the right side, a satellite view of terrain in a particular geographic location is presented with a polyline path 301 superimposed thereon. On the left side of FIG. 3(A), a camera view of what was recorded at a specific location along the polyline path 301 is presented. Similarly, FIG. 3(B) shows a satellite view on the right and a camera view on the left, except in the satellite view, along the polyline path 301, there is also shown a preview window 305, which may essentially be a smaller depiction of the camera view shown on the left of FIG. 3(B). In addition, the preview window 305 may also include identifying information such as the date and time that the particular frame of the video was recorded. Thus, in some examples, it may be possible to display a video as a path and preview the video along the path.

In some examples, the polyline path 301 on the left side of FIGS. 3A and 3B includes a first point representing a location and time along the polyline path 301. The camera view includes slider control including a second point representing a playback time of video data (or other sensor data). A user can interact with the first point to scrub along the polyline path 301 on the left side of FIGS. 3A and 3B. Scrubbing the first point along the polyline path changes the time associated with the point and, in some examples, the scrubbing causes a corresponding change in time in the time associated with the second point of the camera view. That is, one can scrub through the video by scrubbing along the polyline path 301. Similarly, one can scrub along the polyline path 301 by scrubbing the second point along the slider control of the camera view.

In some examples, the views shown in FIGS. 1-3(B) may correspond to video recorded with a UAV. However, according to other embodiments, devices other than a UAV may be used to record video. Exemplary devices in this regard may include any one of the video recording devices described above.

### 1.1 Indexing and Searching

In some examples, searching for videos may be performed by a data-based search. As previously described, traditional text-based searches of video content are limited to titles, descriptions, tag words, and exchangeable image file format (EXIF) metadata. As such, traditional text-based searches often provide limited search functionality.

In other examples, in data-based searches, camera position, orientation, and time to each moment within a video may be linked together. In some examples, the camera position may include a direction that the camera is pointed toward, and/or an angle at which the camera is positioned relative to a point of reference. In some examples, the point of reference may be any particular point in a surrounding environment of where the camera is located. Such linking may provide powerful ways to find places, events, and even objects within videos.

In some examples, a database of trajectory records and/or of video frame data may be created from imported log files generated by, but not limited to, Global Positioning System (GPS)-enabled devices such as those listed above, along with cameras, smart phones, UAVs, and/or 3D model video data extracting methods. The database may be of its own individual component, or it may be integrated with a server device. In other examples, the database may be cloud-based and accessible via the Internet. In some examples, multiple videos may be uploaded and saved in the database. Further, the database may be configured to store more than one video, where each video recording may pertain to a same or different event or location, and at a same or different date or time.

In some examples, a timeline of camera positions may be generated for a particular time period. Once the timeline of camera positions is established, each video frame may be recreated in a virtual 3D world using existing geographic data. In addition, objects within each 3D frame scene may be catalogued and stored in a database index for future reference. Once the database of video frames, each containing a place, object, or event is created, powerful searches may be performed. For instance, in some examples, any part of a video containing some place, object, or event may be returned as a search result. Additionally, in other embodiments, surrounding objects and relevant points of interest may be used in returning search results.

In some examples, related videos may be found using geographic location, similar video frame contents, or events. The geographic location may be a GPS location of the video recording device where the video was recorded. In other embodiments, different videos of a single place, object, or event may be compared using position data, such as GPS data, and date and time information of when the video was recorded. As such, with the recorded videos of the single place, triangulated frames from the videos may be used to create 3D models of a scene or 3D animated models of an event. Thus, in some examples, it may be possible to recreate a scene or event that has already or is currently taking place.

The event, in some examples may correspond, but are not limited to, environmental events related to weather and/or other natural related occurrences such as, for example, rain storms, earthquakes, tsunamis, fires, or tornadoes. The event may also include social events that people participate in, sporting events, or any other real-world situations or occurrences. Other types of events may also be possible in other embodiments.

In some examples, time and position may be referred to as an event in physics. In other embodiments, dynamic moving map layers may be provided beside the video. For example, in an embodiment, third party event data such as weather or earthquake maps may be synchronized with video footage and represented as dynamic moving map layers beside the video. In other embodiments, the third-party event data may be superimposed onto a map with polyline paths corresponding to recorded video. Further, in other embodiments, databases linked by time and/or location may provide valuable insights into various types of events.

In some examples, multiple recorded videos may be linked according to a location associated with the videos. For example, in some examples, a series of videos may be recorded of a place over a particular period of time. The series of videos may allow one to see changes that took place at one location that was recorded during a specific period of time. Further, identical videos may be recorded to ensure that each frame was recorded from the same vantage point as all of the other identical videos recorded at different times. With the identical videos therefore, direct comparisons may be made between the recorded location(s).

In some examples, an automated UAV may be used to record multiple same video missions, over and over again at different times. Using these recorded videos, it may be possible to get close to the same video footage each time a video is recorded during a video mission. However, a complicating factor may be that slight variations may occur in the time between each video frame, carted by variable winds or some other uncontrollable circumstance. If a comparison of frames between all of the videos taken at some number of seconds into each video, it may be possible to find that the frames are all of a slightly different location. In order to correct this discrepancy in location, some examples may link the frames by position, not by time, since linking frames only through time may cause mismatches due to the factors described above.

Furthermore, in some examples, fine-tuning may be implemented using machine vision to correct any slight offsets and reduce image motion from one video's frame to another video's frame. Machine vision may be used to highlight changes between the video frames of different videos, and flag the changes geographically. The changes, in some examples, may include, but not limited to, changes in environmental conditions such as landscape features of a particular location. In addition, the highlighted changes may be illustrated on a map or in a 3D model.

In some examples, video generated 3D models of identical videos over time may be compared with each other to determine volumetric changes of a terrain within a particular location. For instance, the volumetric changes may correspond to changes in the amount of water, sand, or other surrounding natural elements. Such a capability may be useful for land, infrastructure, and city management. Use cases may include, for example, tracking erosion, vegetation and crop cycles, water management, and changes in snow pack and glaciers depth.

In some examples, when data is recorded with video, as it may be when using a UAV, a common frame of reference may be available through position coordinates. Further, if a series of videos was recorded over time using the same camera track, or UAV mission, it may be possible to pause the video and then slide back and forth or toggle through time by retrieving the other video frames taken at the same (or closest) geographic location as the original paused video. Since each historic frame may be linked by camera location, using the same orientation, it may be possible to see changes over time, or time-lapses, for any point within any identical video. In other words, in some examples, it may be possible to connect one video from a video recording device that has been configured with a specific camera position while looking at an object, and another video with a close camera position looking at the same object.

According to other embodiments, videos may be searched for, by any of the methods described above, at specific coordinates. For example, videos may be searched for that have a specific longitude and latitude at a specific day and time. After such videos are found, they may be used to create a time lapse for that particular moment, such as for that particular position, and at that particular time.

In some examples, if a place or event is recorded from different vantage points, additional spatial dimensions may be captured. Knowing where a camera is positioned, where it is pointed, and what its field of view is, along with 3D terrain models, may provide a way to find video footage that contains places or events. In addition, in some examples, videos may be linked by time, proximity of where the videos in addition to places or events. Often, events may be unplanned, but may be captured by different cameras in different places near the event. Data captured with video footage may help find cameras that captured some place or event. The footage from those cameras may be combined to create static or animated 3D models that recreate the place or event. In some examples, it may be possible to extract or find videos at different places by using time and location to see the effects. Such videos may be used for analyzing or surveying disasters such as oil spills, damn breaks, etc., and provide special aid in disaster relief

In some examples, video recorded of some object at the same place and time, may contain footage of an event. Video containing footage taken in a similar area at around the same time may be of the same event, even if the footage does not contain the same objects. As such, some examples may link video time, with place, may provide insights into the cause and effect of a particular event. An example may be footage of an earthquake in one place, and the resultant tsunami in another. Another example may be footage of an eclipse taken from different locations on earth, even in different time zones. According to certain embodiments, it may therefore be possible to extract or find videos at different places by using time and location to see the effects. Such videos may be advantageously used for analyzing or surveying disasters such as oil spills, damn breaks, etc., and provide special aid in disaster relief.

Some examples may further have an effect on relevancy. For example, data may increase relevancy for people's interests. It may provide other relevant and related videos. Further, tools may be used to make sense of what video captured, if data exists to work with. Thus, in some examples, relevancy may be driven by linking videos together using data that is important for search, automated data analysis, advertising, commercial applications, surveillance (flagging events) and trend analysis.

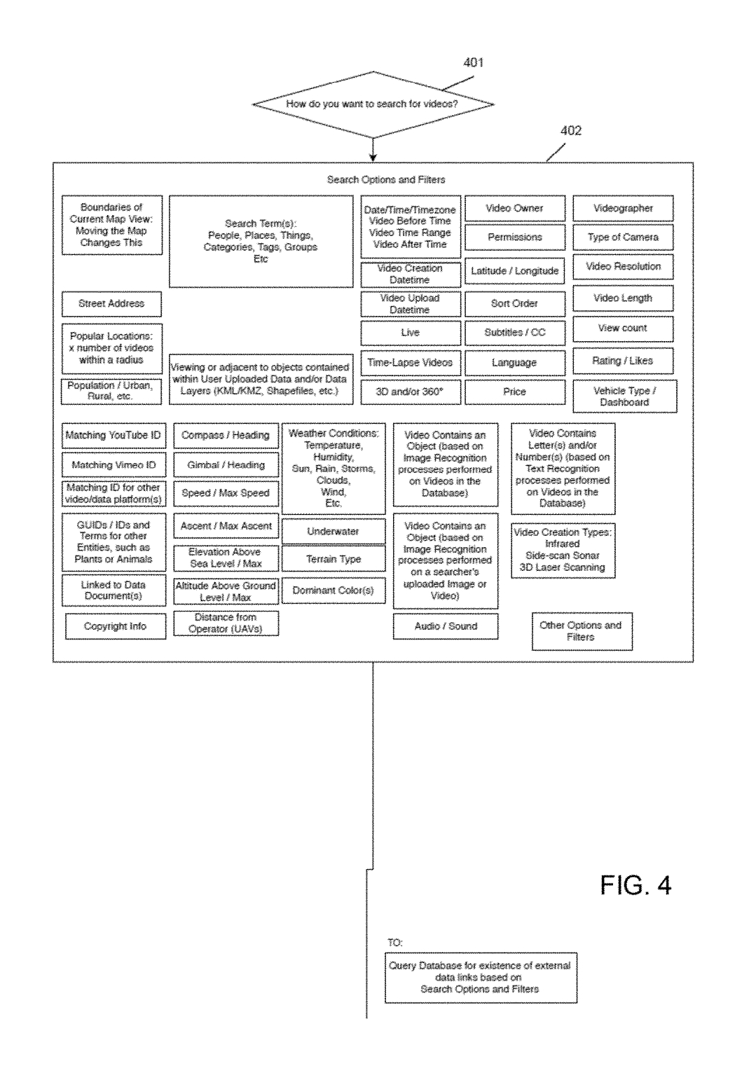

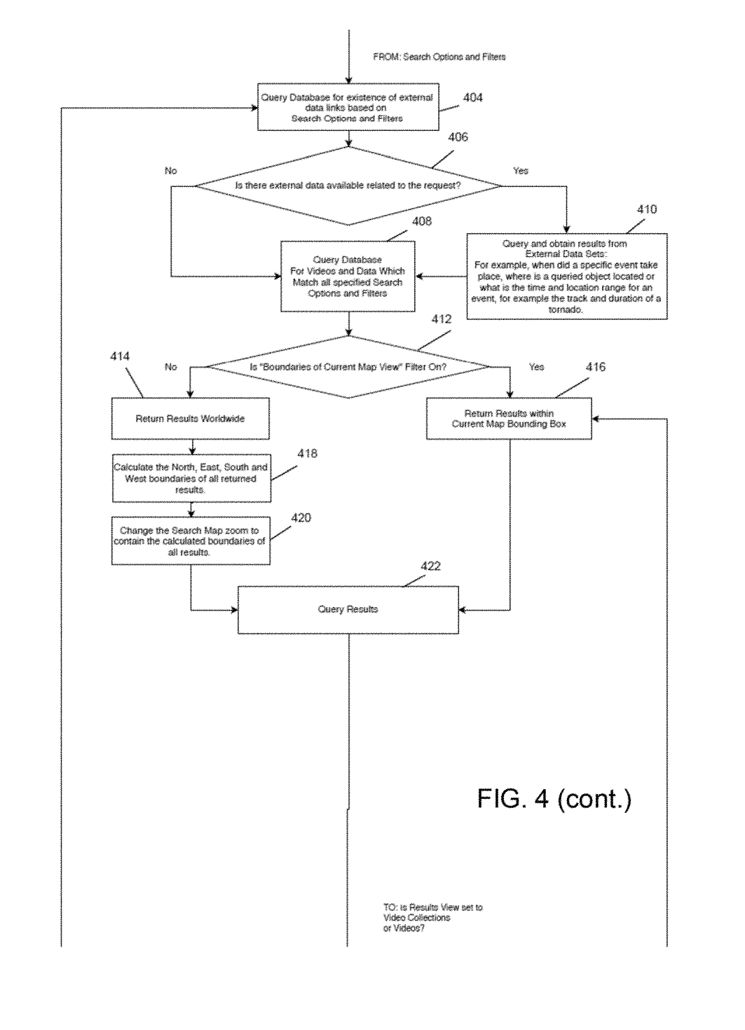

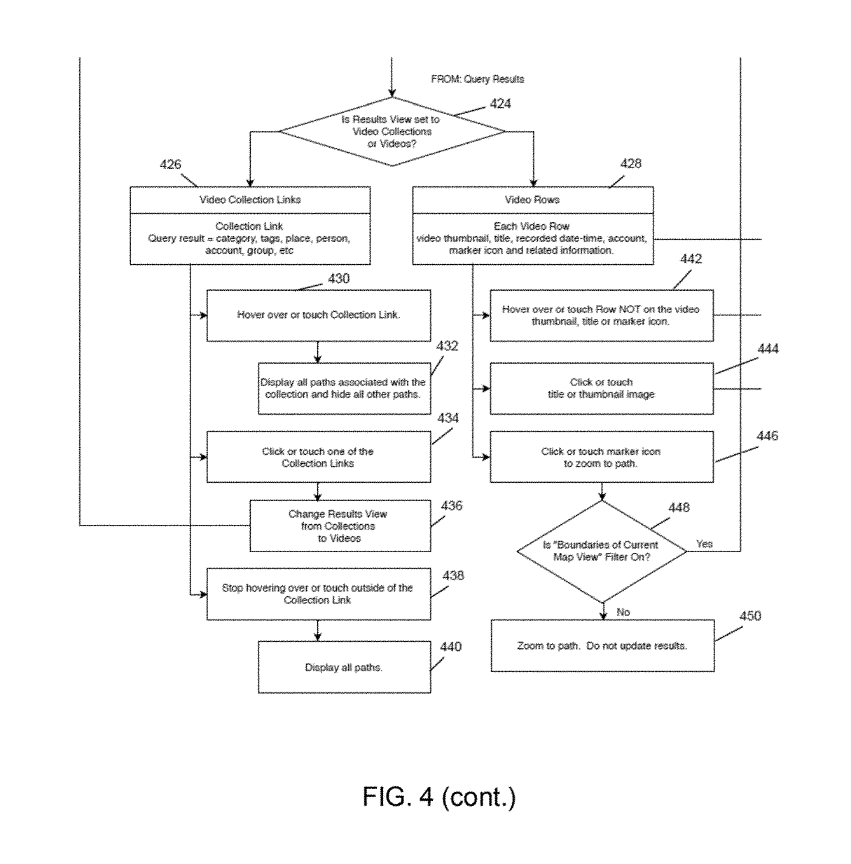

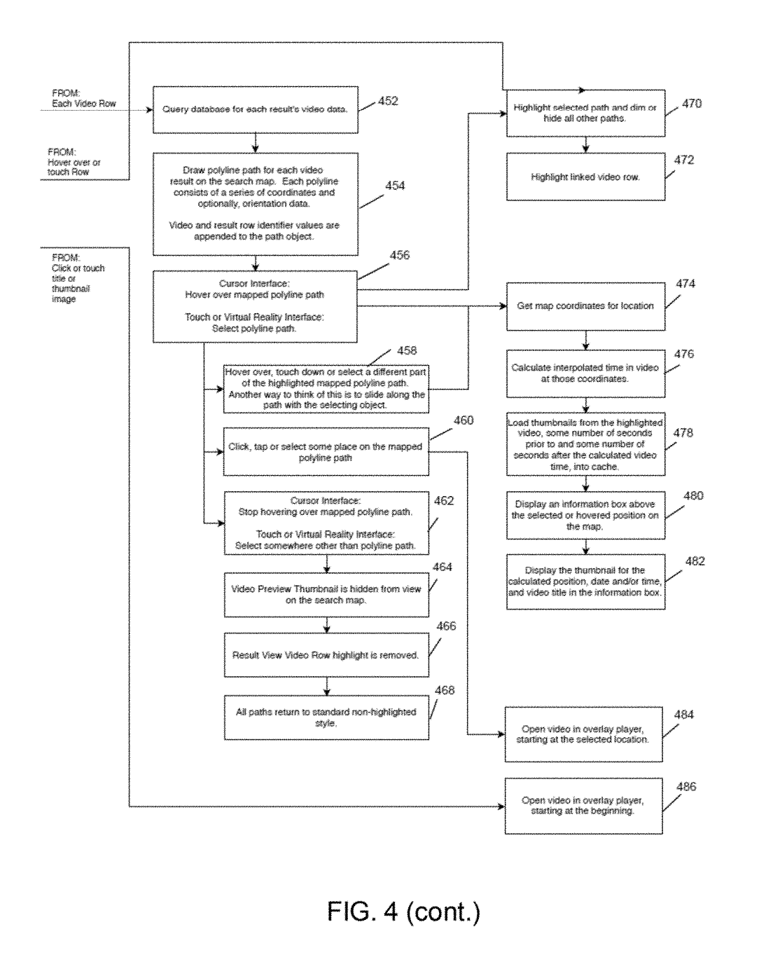

With the database created, videos and/or trajectory records stored within the database may be searched for. Such a search, in some examples, may be performed based on various options and filters that may be set by a user of the computing device via a user interface. Referring to FIG. 4, n flow diagram illustrates an exemplary search procedure. In particular, FIG. 4 shows a flow diagram of how to conduct a search for videos stored in a database. At 401, a user may select how the search for videos may be performed. At 402, the user may select one or more of a plurality of search options and filters for which the search may be based. For example, as shown in FIG. 4, the search options may include, but not limited to the following, which is a summary of the items shown at 402: boundaries of current map view; latitude/longitude; street address; popular locations; population/urban, rural, etc.; various search terms; viewing or adjacent to certain objects; date/time/time zone; video creation date time; video upload date time; live; time-lapse videos; 3D and/or 360°; video owner; permissions; copyright information; sort order; subtitles/cc; language; price; videographer; type of camera; video resolution; video length; view count; rating/likes/vehicle type/dashboard; matching YouTube® ID; matching Vimeo® ID; matching ID for other video/data platform(s); Globally Unique Identifier (GUIDs)/IDs and terms for other entities; linked to data document(s); compass/heading; gimbal/heading; gimbal/max speed; ascent/max ascent; elevation above sea level/max; altitude above ground level/max; distance from operator (UAVs); weather conditions; underwater; terrain type; dominant color(s); video contains an object (based on image recognition processes performed on videos in the database); video contains an object (based on image recognition processes performed on a searcher's uploaded image or video; audio/sound; video contains letter(s) and/or number(s) (based on text recognition processes performed on videos in the database); video creation types; and other options and filters.

At 404, the user may query the database for the existence of external data links based on the search option(s) and filter(s) selected at 402. At 406, it is determined if there is external data available related to the request. If no, then, at 408, the database may be queried for videos and data, which match all of the specified search options and filters. If yes, then, at 410, a query of the database may be carried out and results from the external data sets may be obtained. At 412, it may be determined if the “boundaries of current map view” filter is turned on. If no, then, at 414, worldwide results of videos may be returned. After the results of 414 have been returned, at 418, North, East, south, and West boundaries of all of the returned results may be calculated. Then, at 420, the search map zoom may be changed to contain the calculated boundaries of all of the results.

If it is determined that the “boundaries of current map view” filter is turned on, then, at 416, results may be returned within the current map bounding box. At 422, the results may be queried. Further, at 424, results view may be set to video collections or videos. If video collections are set, then at 426, video collection links may be provided to the user. At 430, the user may hover over or touch the individual collection links, and then at 432, a display of all paths associated with the collection may be presented, and all other paths may be hidden from view except those in that collection. After the hovering is stopped, it may return to showing all paths. Thus, it may be possible to provide an idea of what types of videos are where.

At 434, the user may click or touch one of the collection links, and at 436, a results view from collections to videos may be changed. The user may further, at 438, stop hovering over or touching the outside of the collection link. Then, at 440, all of the paths may be displayed.

If videos are set, then at 428, video rows may be presented to the user. In some examples, at 442, the user may hover over or touch a row, not the video thumbnail, title, or marker icon. Further, at 444, the user may click or touch the title or thumbnail image. At 446, the user may click or touch a marker icon to zoom to a path which the video was recorded. Then, at 448, it may be determined if the “boundaries of current map view” filter is on. If the filter is not on, then at 450, the user may zoom to the path, and the results are not updated.

If at 448, it is determined that the “boundaries of current map view” filter is on, then, the flow diagram may return to 416. In addition, once it is determined that the results view is set to videos, at 452, the data base may be queried for each result's video data. At 454, a polyline or path that is drawn on a map or virtual 3D world for each video may be returned. Further, at 456, with a cursor interface, the user may hover over a mapped polyline path on a map, and in a touch or virtual reality interface, the user may also select a polyline path. The user may also, at 458, hover over, touch, or select a different part of the highlighted mapped polyline path. In addition, at 460, a place on the mapped polyline path may be clicked on, tapped on, or selected. Further, at 462, with a cursor interface, the user may stop hovering over the mapped polyline path, and with a touch or virtual reality interface, somewhere other than a point on the polyline path may be selected.

At 464, a video preview thumbnail may be hidden from view of the search map, and at 466, a result view video row that has been highlighted, may be removed. Further, at 468, all of the polyline paths may return to a standard non-highlighted style. In addition, 456 may lead to 470, where a select path may be highlighted, and at 472, the linked video row may be highlighted. Further, from 456, a map of coordinates for a particular location may be obtained at 474. Then, at 476, an interpolated time may be calculated in the video at the map coordinates for the specific location. At 478, thumbnails from the highlighted video and various other items may be loaded, and at 480, an information box may be displayed above the selected or hovered position on the map. In addition, at 482, the thumbnail for the calculated position, date and/or time, and video title in the information box may be displayed.

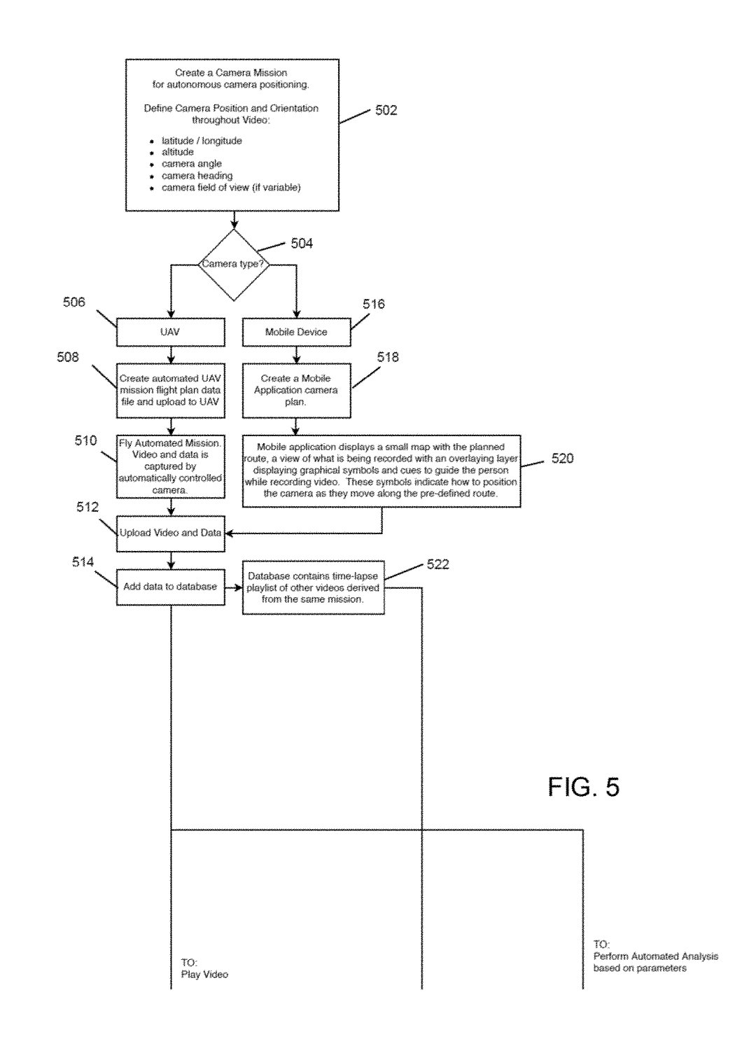

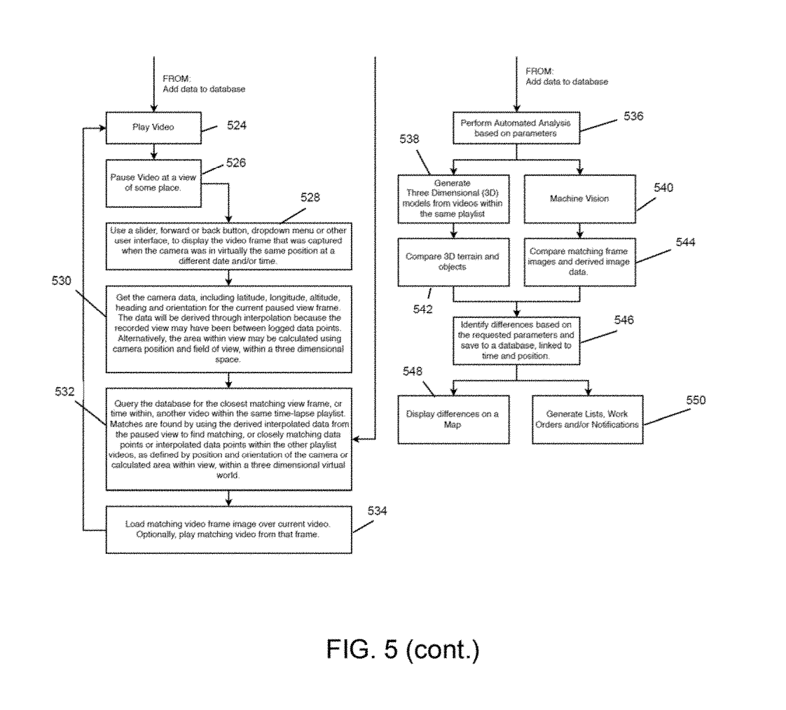

FIG. 5 illustrates another exemplary flow diagram 500 in some examples. In particular, FIG. 5 shows a flow diagram of creating and viewing a time-lapse playlist in some examples. At 502, a camera mission may be created for autonomous camera positioning of a video recording device. In addition, camera positions and orientations may be defined throughout the video to be recorded. Such position and orientations, in some examples, may include latitude and longitude, altitude, camera angle, camera heading, or camera field of view (if variable). At 504, a camera type of a video recording device may be selected. The camera type may be of a UAV at 506, or a mobile device at 516. If the camera type is of a UAV, then at 508, an automated UAV mission flight plan data file may be created and uploaded to the UAV. In some examples, the flight plan data may be created, via a user interface, by selecting a particular location on a map, and automatically generating a flight path for the UAV. In an alternative embodiment, the flight plan data may be created by a user, via the user interface, physically drawing on a map displayed on an electronic computing device, and manually defining the camera parameters such as camera angles, and longitude and latitude coordinates throughout the flight. Since the flight plan data and camera parameters are known, the position of every captured frame may also be known. In addition, it is also known of when the frame was shot, and where the camera was looking while recording the video. With the known information therefore, it may be possible to synchronize and link the frames in the recorded video with frames of previously recorded video, and determine which videos belong to similar sequences.

At 510, the UAV may be instructed to fly the automated mission, video and data may be captured by the automatically controlled camera. Once the video and data have been captured, at 512, the video and data may be uploaded to an electronic computing device, such as a server or desktop or laptop computer. Then, at 514, the uploaded video and data may be added to a database of the server or desktop or laptop computer. At 522, the database may contain time-lapse playlists of other videos derived from the same mission. That is, in some examples, as flight missions are repeated, and more videos and data are uploaded and added to the database, the newly added videos and data may be grouped with previously added video and data that contain similar or related video sequences.

Once the video and data have been added to the database, the video may be played at 524. Further, at 526, the video may be paused at a view of a certain place of a particular location. Then, at 528, a user, via a user interface, may use a slider, forward or back button, dropdown menu, or other user interface, to display the video frame that was captured when the camera was in virtually the same position at a different date and/or time. Once the particular video frame has been selected, at 530, camera data may be obtained. In some examples, the camera data may include, for example, latitude, longitude, altitude, heading, and orientation for the current paused view frame. The data may be derived through interpolation since the recorded view may have been between logged data points. Alternatively, the area within view may be calculated using camera position and field of view, within a three-dimensional space.

At 532, the database may be queried for the closest matching view frame from that selected at 528, or the database may be queried for the time within another video within the same time-lapse playlist. Matches may be found by using the derived interpolated data from the paused view to find matching, or closely matching data points or interpolated data points within other playlist videos, as defined by position and orientation of the camera or calculated area within view, within a 3D virtual word. Querying the database may also occur from 522 once the time-lapse playlist of other videos derived from the same mission have been acquired. At 534, the matched video frame image may be loaded over the current video. In addition, the matching video from that frame may be played as well.

As further shown in FIG. 5, as an alternative to playing the video at 524, an automated analysis of the video may be performed at 536. For instance, at 538, 3D models may be generated from the videos within the same playlist. At 542, the 3D terrain and objects of the 3D models of different videos may be compared against one another. With those models, at 546, differences between the models may be identified based on the requested parameters that were set. After the comparison, at 548, the detected differences may be displayed on a map, and at 550, lists work orders, and/or notifications may be generated in order for some form of action to be taken with regard to the detected differences. In other embodiments, the differences may be marked and identified on a map.

As an alternative to, or in conjunction with, generating the 3D models at 538, machine vision may be implemented at 540 to provide imaging-based automatic inspection and analysis of the content of recorded video, such as the terrain or objects (e.g., trees, water levels, vegetation, changes in landscape, and other physical environmental conditions). At 544, matching frame images and derived image data may be compared against each other based on the analysis performed with machine vision at 540. After the comparison at 544, the remaining flow may continue to 546, 548, and 550 as described above.

As further shown in FIG. 5, if a mobile device is selected as the camera type at 516, then the flow diagram may proceed to 518 to create a mobile application camera plan for recording video. After the mobile application camera plan has been created at 520, recording may begin, and the mobile application may display a small map with the planned route. Also displayed may be a view of what is being recorded with an overlaying layer displaying graphical symbols and cues to guide a person performing the recording while recording the video. In some examples, these symbols may indicate to the person recording how to position the camera as the person moves along the pre-defined route. Once the video has been recorded, the flow may proceed to 512-550 as described above with regard to the selection of the UAV.

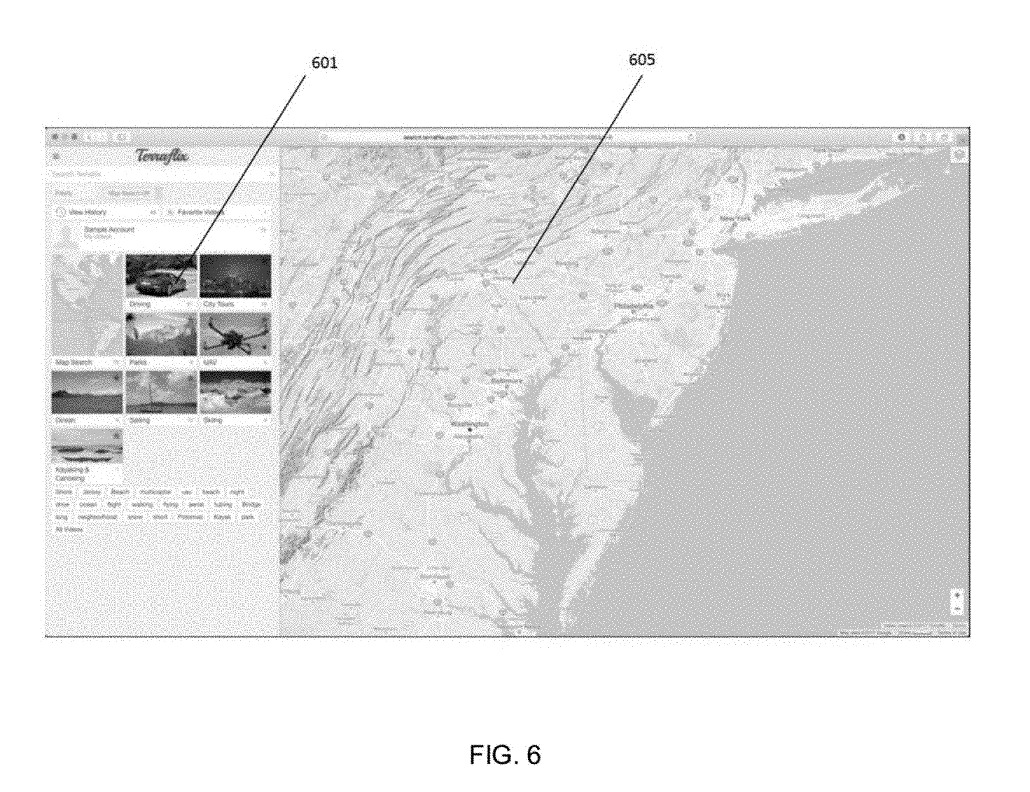

As noted above, video collections may be presented as a result of a search for videos. Referring to FIG. 6 an exemplary view of various sets of video collections 601 and a map view 605 corresponding to the different video collections is shown. In some examples, search video collections may be dynamically created as part of a search, custom tailored for each user, or may be previously generated. The search video collections may include related video tags or categories, accounts, groups, related to some object, a playlist, etc.

### 2 Additional Features

In some examples, a device used to capture a particular video does not have access to GPS or other location data as the video is being captured. In such cases, the frames of the captured video (or a generated three-dimensional representation determined from the frames of the captured video) are analyzed to determine an estimated trajectory of the device as the video was captured. For example, the frames of the captured video (or a generated three-dimensional representation determined from the frames of the captured video) are compared to a model of a geographic area (e.g., a map of the geographic area or a three-dimensional representation of the geographic area such as Google Earth) using, for example, machine vision techniques to determine the estimated trajectory of the device as the video was captured and also using, for example, 3D alignment of the generated three-dimensional representation from the frames of the captured video with the 3D model of the geographic area.

In some examples, if no model of the geographic region is available, other information such as accelerometer data to determine an estimated trajectory of the device as the video was captured. In such cases, the estimated trajectory is not represented according to any particular coordinate system.

In some examples, geospatial data may be used to create ground-based, subterranean, marine, aerial and/or space missions for the purpose of collecting and recording video, imagery and/or data. In some examples, data may be, but is not limited to, visual, infrared, ultraviolet, multispectral, and hyperspectral video or imagery, Light Detection and Ranging (LIDAR) range finding, from gas, chemical, magnetic and/or electromagnetic sensors. According to other embodiments, public and/or private geospatial data may be utilized to create video, image and data collection missions. This may therefore allow for more precise video, image and data collection, reducing pilot or videographer workload and tracking ground or aerial missions with geospatial tools.

In some examples, geospatial data may be stored in databases or in a variety of file formats. This data may include, but is not limited to, geometrics, information about the geometry in whole or in part, uniform resource locator (URL) or other links to additional data, projections, imagery, video, notes, and comments. The geometric data may include, but is not limited to, polygons, curves, circles, lines, polylines, points, position, orientation, additional dimensions including altitude, latitude and longitude or other coordinate systems, reference points, and styling information. These data sets may be sourced by a service provided by some examples, provided by a third party, uploaded by the user, or created on a service of some examples. The data sets may also be in a database, file, or data stream form in whole or in part.

In some examples, geospatial data may be represented as, or used for and is not limited to, the creation of a map or part thereof, map layer, imagery or video layer, set of instructions or directions, planning and/or guiding automated or manned ground, subterranean, marine, submarine, aerial or space travel, or database search. In addition to numeric, time, text, and other traditional searches, geometric queries may be performed on spatial databases to find results that may include, but are not limited to, overlapping, adjacent, intersecting, within or outside of some bounds, changes in size, position or orientation, or shape type. In other embodiments, additional query conditions may apply, adding to or filtering the data sets.

In some examples, video may be recorded and/or captured. In some examples, such video may be recorded, and a search for recorded video content may be performed by various electronic devices. The electronic devices may be devices that have video recording capabilities, and may include, for example, but not limited to, a mobile phone or smart phone or multimedia device, a computer, such as a tablet, laptop computer or desktop computer, provided with wireless communication capabilities, personal data or digital assistant (PDA) provided with wireless communication capabilities, cameras, camcorders, unmanned aerial vehicles (UAVs) or remote controlled land and/or air vehicles, and other similar devices.

In some examples, the video and software output may be displayed as graphics associated with an interactive user interface, whereby active icons, regions, or portions of the material are displayed to the user, including, for example, videos, maps, polylines, and other software output displays. Such user can select and/or manipulate such icons, regions or portions of the display, and can be selected or manipulated by user to by use of a mouse click or finger.

In some examples, the video recorded by the video recording device may include identifying information that is specific to the recorded video content and/or the video recording device. For instance, in some examples, the identifying information may include video data such as a particular date and time that the video was recorded, the position and/or orientation of the video recording device while it was recording, the location of the video recording device at the time the video was recorded, and other data recorded together with the video, or derived from a video. With the identifying information, some examples may be able to view and link or associate one or more videos together based on the identifying information. For example, according some examples, when performing a search for videos using a user interface installed on a computing device, such a search may be performed based on the identifying information of the video(s).

In some examples, data layers may be added to a base map. For instance, in some examples, software maps and map services or application program interfaces (APIs) may allow users to add data layers to a base map. These layers may represent the position, size, boundaries, route or some other state of static or dynamic geospatial data.

In addition to the above, geospatial data may further include static geospatial data. Static geospatial data may include, but is not limited to, geographic boundaries, infrastructure such as roads and their associated features, waterways and bodies of water, storm and other drainage systems, dams, bridges, power lines, pipelines, poles, towers, parcels, buildings, parking lots, industrial equipment, regions, parks, trails,

In some examples, video and imagery may be found using geospatial data and video metadata. For instance, in some examples, metadata may be recorded throughout the duration of a recorded video. Further, a map-based search may be performed that finds results for any part of a video that is represented by some metadata coordinates that are within the map view. In some examples, each search result may be displayed as a two or three-dimensional polyline, representing one or more videos and/or data. These videos and/or data may be recorded in multiple wavelengths and/or fields of view.

In some examples, visible map boundaries may include a box, and the box may include east and west longitudes, and north and south latitudes. The bounding box, in some examples, may be used to find overlapping video metadata paths. In other embodiments, the video metadata paths, represented as geometric data, may be used to find other geometries by finding overlaps, intersections, proximity, data inside of, or outside of, statistical and other algorithm limitations, calculated, or observed or stored dynamic objects. In some examples, the observed or stored dynamic objects may include, but not limited to moving shapes where time and position for both the video metadata and the object may be used with one of the aforementioned conditions.

In some examples, the reverse may also be true where videos, imagery, and data may be found by selecting and running the same conditions on static or dynamic geospatial data in numeric, text, vector, raster, or any other form. In other embodiments, additional search conditions may be applied, expanding or reducing the dataset. For instance, altitude, time, speed, duration, orientation, g-forces and other sensor data, machine vision, artificial intelligence or joined database queries, and other conditions may be used.

In further embodiments, video or objects such as, but not limited to, land, waterways, bodies of water, buildings, regions, boundaries, towers, bridges, roads and their parts, railroad and their subparts, and infrastructure may be found using projected, for example, calculated field of view or some part thereof

According to further embodiments, individual video frames or sections of video may be found by defining some area or selecting some geospatial obj ect(s), or part of an object, or referencing one or more pieces of data related to one or more objects that contain or are linked to geospatial data. The individual video frames or sections of the video may also be, but not limited to, represented as a mark or marks on a map or map layer, video's camera path polyline, or camera's calculated field of view represented as polylines or polygons, all of which may be represented in two dimensions or three dimensions.

Further, in other embodiments, related videos may be found by searching for conditions where one video's camera route or view area intersects with another's. This intersection may be conditioned upon time and/or location of a static geospatial object or may be of the same object at two different places and times. An example may be an event such as a tsunami or a storm where the object moves, and there may be videos taken of that moving object from different places and vantage points at different times. Such videos may be found through their relationship with that object, irrespective of position or time. Further, in some examples, conditions may be set, depending on the desired results. An example may be where videos recorded of an intersecting region, at the same time, from different vantage points, may be used to derive multidimensional data.

In some examples, statistical modeling of static or dynamic geometric data may be used to generate a video job or a condition on a query. An example may be, but is not limited to, a third-party data source, such as social media, being used to flag an area of density that indicates some unusual event that warrants a video recording or search. This type of geometric data may be derived from, but is not limited to, the Internet of Things (IOT), mobile phone location data, vehicle data, population counts, animal and other tracking devices and satellite data and/or imagery derived points of interest.

In some examples, cataloging and indexing searches may be performed. For instance, in some examples, videos and geospatial objects may be indexed to enable rapid search. Further, cataloging may organize this data so that future, non-indexed searches may be performed and allow dynamic collections to be built. In some examples, these collections may have some user or platform defined relationships. The video collections may also be built by finding related geospatial object types including, but not limited to region, similar or dissimilar motions, speeds, and locations. These saved collections may be added to by the user or automatically by the platform.

Examples of the saved collections may include, but not limited to: all videos, video frames, imagery and/or recorded metadata that include data that is over 1000 miles per hour and over 40,000 feet and sort by highest g-forces; all videos, video frames, imagery and/or recorded metadata that include the selected pipeline; all videos, video frames, imagery and/or recorded metadata that include some part number associated with an object; all videos, video frames, imagery and/or recorded metadata that include some geometric or volumetric geospatial change within the same video, or compared to other videos or imagery; and all videos, video frames, imagery and/or recorded metadata that include an intersection with a group of people moving at over 4 miles per hour.

In other embodiments, geospatial data may include dynamic geospatial data. Dynamic geospatial data may include, but is not limited to, current near/real-time, historic or projected data such as moving weather systems, tornados, hurricanes, tsunamis, floods, glacier fronts, icepack edges, coastlines, tide levels, object location (person, phone, vehicle, aircraft, Internet of Things (IOT) object, animal or other tracking devices (global positioning system (GPS) or otherwise), etc.), or calculated crowd area.

In some examples, geospatial data, displayed as map layers, may be in mathematical geometric shapes known as a vector format, or it may be in a raster image format represented as pixels. In some examples, a variety of geospatial vector file formats may be used. The variety of geospatial vector file formats may include points, lines or polylines, polygons, curves, circles, three-dimensional (3D) point clouds, or models etc. These geometric objects may have metadata associated with them that may include information such as a title, description, uniform resource locator (URL), parcel identifier, serial number, or other data. This geospatial data may be stored as files or within one or more databases.

In some examples, layers and their associated objects may be positioned on a map or virtual world using a variety of projections, ensuring optimal alignment. Further, in some examples, map or virtual world layers may be made up of one or more static or dynamic geospatial data sets. In addition, maps or virtual worlds may contain any number of layers in various arrangements including, but not limited to, stack orders, styles, and visibility levels. In some examples, each layer may contain one or more individual static or dynamic (moving) objects. These objects may be represented as one or more geometric shapes that may be selected individually or collectively.

In some examples, each object, by virtue of its parent layer's positioning, may also have a known position. Whether visually represented in two or three dimensions, included metadata, or external associated data may be used to calculate an object's size, position, and orientation in space. In addition, position and orientation may be calculated, but is not limited to, latitude, longitude, altitude, azimuth, or any other spatial calculation method, and is not limited to earth-bound measurement methods. In other embodiments, object location may be determined using available geometric location data, as represented by the layer vector data, or may link to another data source. Further, related data sources may be, but is not limited to, a form of live stream, database, file, or other local or remote data.

In some examples, a mission plan may be generated. In generating a mission plan in some examples, a user may wish to request data, video, or imagery of some place or event. Within the service on their computer or mobile device, the user may select an object(s) within the mapped data layer. Selected objects may then be used to create a video job. Further, each object's shape may be made up of a collection of one or more lines, curves, and/or points that define its boundaries. In addition, each object may include an area or volume within those boundaries.

In some examples, shapes may also be created by the mission planner. Routes created completely independent of existing map data layers may be created directly on a map or three-dimensional virtual world. Further, in some examples, due to the known position of each point on a selected shape, a series of latitude and longitude coordinates may be created. If the object is in three dimensions, altitude may also be calculated. Alternatively, LIDAR and other elevation data may be referenced for each coordinate point to provide three dimensions. In the case of static data, this may be sufficient to move to the next step. In the event that a dynamic, currently moving object, or a calculated future position was selected, the changing three-dimensional position must be referenced to time. Furthermore, dynamic feedback loops may be implemented where the projected object's position in time used to generate the initial mission is cross checked against current position as the mission is being carried out to ensure the selected object remains the target.

In some examples, upon selecting the targeted object, a variety of tools may be used to modify the flight plan to provide different points of view and remain clear of obstacles. One example may be to set the altitude of a UAV over a terrain and building elevations. Adding some altitude above the ground for each point along a planned route enables nap of the earth missions. This ensures that the UAV follows the terrain, remaining at a safe altitude above obstacles while also remaining within legal airspace.

In some examples, routes may be along a map layer shape's boundary, the centerline of a road, river, railroad, or other linear ground, marine or aerial route, around a fixed point or shape. Further, UAV or camera routes may match the object shape but be offset by some distance and may approximate the shape of the object or polyline but taking a simpler curved or linear route to minimize small camera or UAV adjustments. An example, a UAV would be following a simplified route, such as that calculated by the Douglas-Peucker algorithm that approximates the center of a river or stream. Further, missions may define the camera's route or the camera's view. In some examples, using geospatial data to drive the camera view may require calculating the camera's position and dangle at close intervals, generating separate camera position and angle mission data.

In some examples, a manual or automated mission may be created using the selected geospatial data. Various attributes may be set, such as camera angle, distance, height, camera settings, camera type (visual, infrared, ultraviolet, multi spectral, etc.). The final mission camera route, view information, and other data may be sent to the videographer or pilot for a manual or automated mission.

In other embodiments, automated missions may be performed. Mission data derived from the geospatial data may be used by a manned aircraft's autopilot, UAV, hand held camera gimbal, helicopter gimbal, mobile device, action or other camera, manned, remote control or autonomous vehicle, boat, submarine, or spacecraft. Further, the platform vehicle and/or camera may be positioned automatically using the mission data. In some examples, mission data may also be used to indicate to a videographer where to go and where the camera, smartphone, gimbal or vehicle should be pointed for the desired footage. In the case of some hand-held gimbals, directions may be given to a human operator for general positioning while the gimbal positions the camera or smartphone on the desired target.

In some examples, dynamic geospatial or machine vision identified objects may be followed. Sequential videos may be taken of moving events, capturing objects at different places. In cases where multiple videographers take part, missions may be handed off from one to another user, keeping a moving object within view.

In some examples, big static object jobs may be divided into multiple linked missions. For instance, several videographers may each perform a mission segment. Further, automated missions may ensure precise positioning, enabling a continuous series of video frames along a route and a smooth transition between UAV videos.

In some examples, missions may be pre-planned or performed live. Missions may also be completely driven by the geospatial data or may be modified by a user (requestor or videographer/pilot), artificial intelligence, machine vision, or live data stream input in real-time. Further, live video/data feeds may be interrupted with a new mission requests if the videographer makes their stream or position available to other users. In addition, available user camera positions may be displayed on a dynamic layer, making them available for contract jobs.

In some examples, live streaming of video and data from the video recording device may be provided. As each piece of data and video arrives, they may be added to a database. In some examples, live video and data may be part of a video collection or included in a search. Video path polylines may be updated from time to time on the search and play maps as more data is appended from the live data stream. In addition, selecting a growing video path (or live video row) may enable entrance of that particular live stream, and therefore allow for viewing of the live stream. The path recorded during the live stream may represent the history of the stream, and an option to go back to the current live time may also be available.

### 3 Live Video Capture and Interface

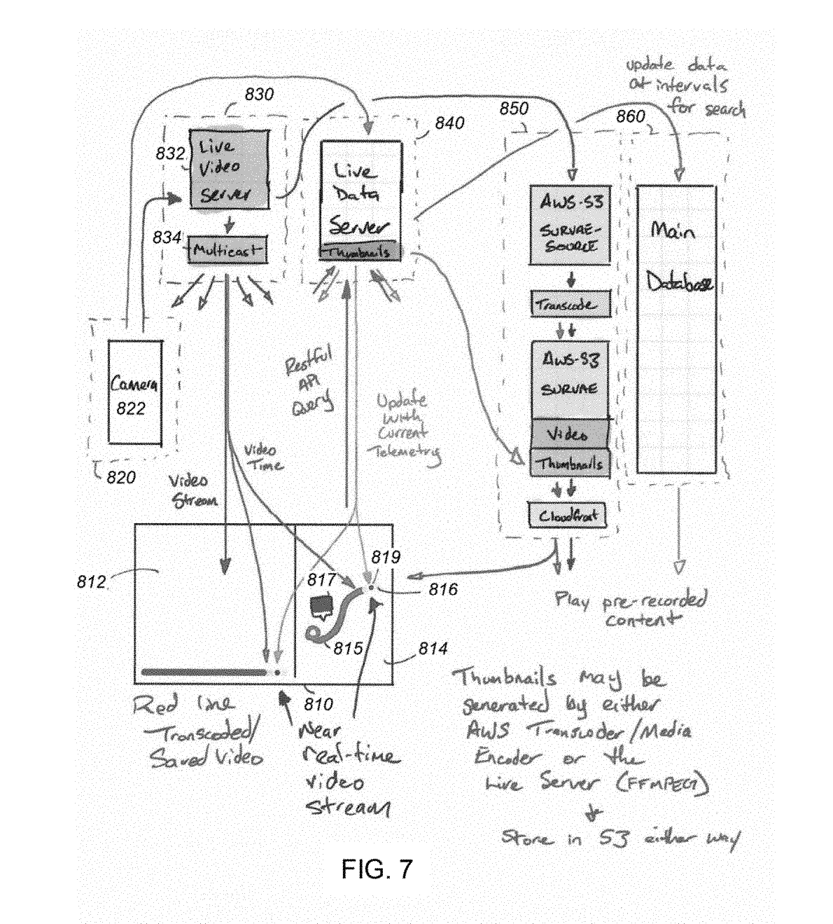

Referring to FIG. 7, in one example, a camera 822 (for example, a phone camera and/or a camera traveling in a vehicle 820) is used to acquire information including video and telemetry data. The video is passed to a video server 830, which includes a cache 832, and a multicast output component 834. The multicast output component passes the video (in an unprocessed form) to an interface system 810. The telemetry data passed from the camera 822 to a data server 840 over a separate path than the video. The telemetry data is passed from the data server to the interface system 810.

The video server 830 also passes the vide to a video processing system 850, where processing can include transcoding, compression, thumbnail generation, object recognition, and the like. The output of the video processing system is also passed to the interface system.

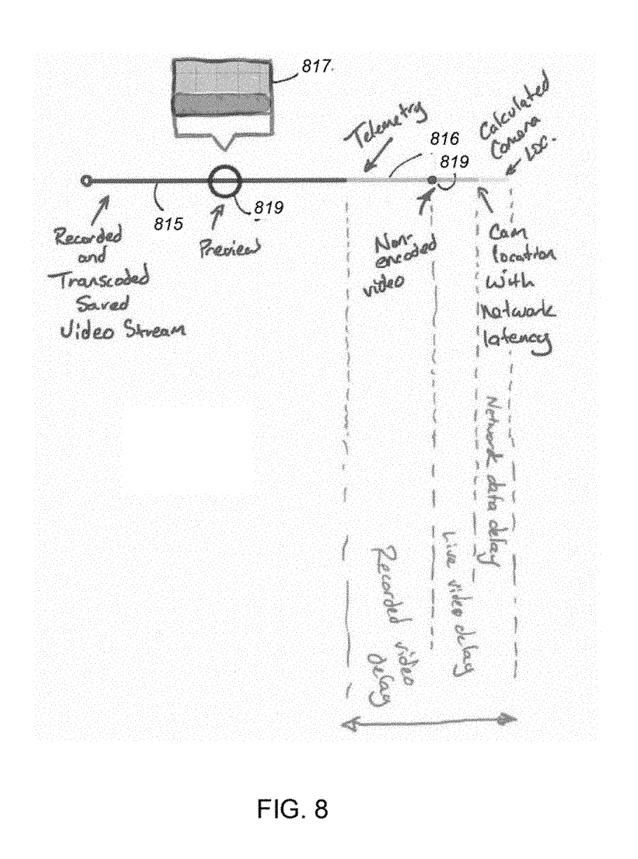

The interface system receives versions of the information acquired from the phone from the video server 830, the data server 840, and the video processing system 850. As introduced above, each of these sources may provide their versions with different delay. The interface system 810 includes a display 812, which renders the versions of the information as it becomes available, such that the manner in which the information is rendered indicates what parts are available. For example, the display 812 includes a map interface part 814, where a path of the vehicle is shown. In the figure, a grey part 816 shows a part of the trajectory where telemetry data is available, but the video is not yet available. A red part 815 of the trajectory shows where the video is available, and a thumbnail 817 shows where the processed form of the video becomes available along the trajectory. Referring to FIG. 8, further detail of graphical annotation of the trajectory shown in FIG. 7. For example, a preview cursor 819 allows the user to select a point along the trajectory to view, and an indicator 819 shows the user where unencoded video is first available along the trajectory.

Aspects can include one or more of the following features. In some examples, video is streamed from a camera (UAV, robot, submarine ROV, automobile, aircraft, train, mobile phone, security camera, etc.). In some examples, the video stream is RTMP, MPEG-DASH, TS, WebRTC, a series of still frames or frame tiles, or some other format. In some examples, the video is stream is streamed, to a server directly, to a viewer directly (peer to peer), through a viewer to a server, or relayed through a mesh network, some nodes being viewers and others being servers, capturing the stream.

In some examples, live streams are cached remotely, on the destination video server or on notes within a mesh for relay, especially when poor connectivity exists. The date and time of the video may be streamed together within the video metadata, data packets, may added by the server, etc., indicating the start, end and times at some interval within the video stream. Other data may be included within the stream, such as that conforming to, but not limited to, the MISB format (KLV).

In some examples, the video server immediately distributes (multicasts) streams to viewer devices in a form that they can handle, for near-real time delivery. In some examples, the video is captured (saved) to a storage device and/or cache (random access memory, etc.), for review—possibly while the viewer is still watching the live stream or at some later time. In some examples, the captured stream is converted (transcoded) to a format that may be consumed by viewers (e.g., HLS, MPEG-DASH, FLV, TS, etc.) via a variety of protocols (e.g., TCP, UDP, etc.) In some examples, thumbnails are generated at some interval and stored them to a storage device.

In some examples, embedded metadata is extracted and saves it to storage, including but not limited to a database or file, for either immediate processing, delivery or storage. Upon stream completion, or mid-stream, transcoded video streams may be copied to another location for retrieval or further processing. Thumbnails may be copied to another location for future distribution. In some examples, the video server is a caching device, offering very fast speeds for delivery of video and preview thumbnails while viewers are watching a live stream. The video server then offloads the content to be stored and distributed from a larger location.

In some examples, live telemetry and/or data from a camera or a separate data capture or logging device (e.g., GPS data, inertial data, pressure data, and other data is streamed to data storage locations that may include a database, file, or another storage format. Some implementations use a REST API. In some examples, date and time information of the data may be included with the data (e.g., associated with each record or with an entire data file in a header). In some examples, date and time data is added by the server. In some examples, data is saved (e.g., cached) to a fast database for immediate distribution to viewers. In some examples, saved data is then be forwarded to a larger storage location (e.g., a main database). Data, from either the live data caching server or the larger main data store may be used for search and retrieval. In some examples, the data is used for analysis or to perform additional queries.

In some examples, live video is delivered to the viewer in a format that is compatible with the client viewer. In some examples, the source stream is delivered to the client viewer. In some examples, a saved or transcoded stream is delivered to the client viewer when the viewer wishes to view previous captured content within the stream or when the source stream is incompatible with the viewer's browser, software or device. In some examples, the video is delivered from a caching live video server. In some examples, the video is delivered from a content delivery network. In some examples, the client viewer displays either the current (fastest) live stream available (“LIVE”) or the slower stored, usually transcoded, stream (“SAVED”).

In some examples, the video player includes a video viewing area, controls, a timeline (typically called a scrub bar), and optionally a map with the captured, time synchronized route of the video. In some examples, the timeline scrub bar represents the SAVED stream duration, which lags behind the LIVE stream. In such cases, the bar may ONLY indicate the SAVED stream, the current duration of which is displayed as the full width of the scrub bar. The timeline scrub bar may display the SAVED stream as a width determined by time percentage of the whole LIVE stream duration. In some examples, there is a gap at the leading edge of the scrub bar, indicating the delay from current telemetry time to availability of saved and/or transcoded content and/or thumbnails. In some examples, the leading-edge gap may also be extended to include the actual current time, which would include the network latency for telemetry data.

In some examples, the timeline scrub bar represents the available LIVE video stream time may be indicated along the timeline, ahead of the stored and/or transcoded video and/or thumbnails, but behind (to the left of) the right side of the scrub bar timeline, indicating either current time, or the latest telemetry data. In some examples, the timeline scrub bar represents both the timeline LIVE, SAVED, and telemetry, with but not limited to different colors or symbology for each type. Generally, the timeline styling will correlate with the mapped route styling.

In some examples, the video player map indicates the route of the camera, and optionally the view area of that camera, whether cumulative through the video, or for each frame. In some examples, the telemetry data generates a polyline drawn on the map, representing the route of the camera to that time. In some examples, another polyline is drawn on top of the telemetry polyline, representing the available SAVED video. This polyline offers hover thumbnail preview, delivered from either the caching video server transcode or CDN, by referencing time, and may be clicked to change the video time to match the time at that geographic location, within the video. This polyline is updated by querying the server for the latest time and or duration of recorded data. The end point of the polyline is updated to represent that geographic position on the map that matches the time that the camera was there. In some examples, a third marker indicates the most current available LIVE stream position. This marker will be somewhere along the telemetry polyline, generally lagging behind it due to LIVE stream network latency but generally ahead of the saved and/or transcoded stream polyline. The gap between the SAVED polyline and the LIVE stream marker indicates the delay caused by storing and/or processing the LIVE video stream.

In some examples, the starting time of video and/or data streams are synchronized. In some examples, the start times are derived by the camera, device, video server and/or data storage (database). Fine tuning the synchronization may be accomplished by measuring the network latency for both the video and the data streams. In some examples, the data is delivered first and the video is attached to it, visually via timeline scrub bars and through the mapped routes and associated polylines and markers. This type of visual representation gives viewers a sense of the delays in the network, provide an almost real-time sense of the camera's current location and give viewing options for fast near-real time or saved content. In some examples, latencies and delays are represented with alphanumeric times.

Components described above may be computer-implemented with instructions stored on non-transitory computer readable media for causing one or more data processing systems to perform the methods set forth above. Communication may be over wireless communication networks, such as using cellular or point-to-point radio links, and/or over wired network links (e.g., over the public Internet).

### 4 Implementations

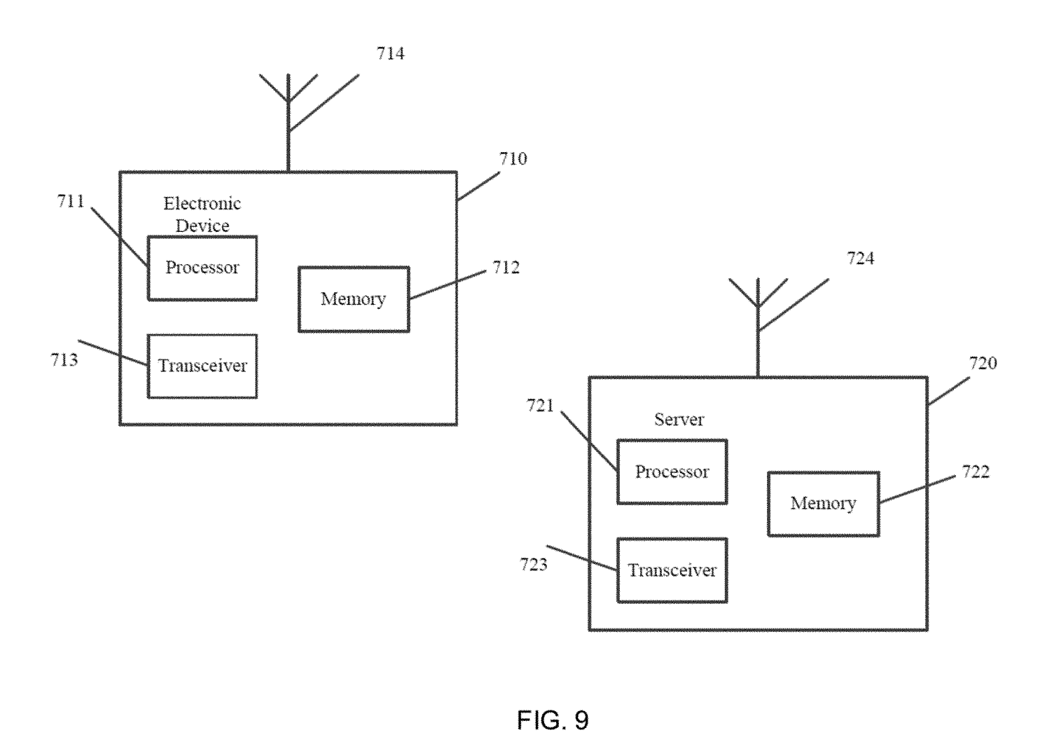

FIG. 9 illustrates an exemplary system. It should be understood that the contents of FIGS. 1-8 may be implemented by various means or their combinations, such as hardware, software, firmware, one or more processors and/or circuitry. In one embodiment, a system may include several devices, such as, for example, an electronic device 710 and/or a server 720. The system may include more than one electronic device 710 and more than one server 720.

The electronic device 710 and server 720 may each include at least one processor 711 and 721. At least one memory may be provided in each device, and indicated as 712 and 722, respectively. The memory may include computer program instructions or computer code contained therein. One or more transceivers 713 and 723 may be provided, and each device may also include an antenna, an antenna respectively illustrated as 714 and 724. Although only one antenna each is shown, many antennas and multiple antenna elements may be provided to each of the devices. Other configurations of these devices, for example, may be provided. For example, electronic device 710 and server 720 may be additionally configured for wired communication, in addition to wireless communication, and in such case antennas 714 and 724 may illustrate any form of communication hardware, without being limited to merely an antenna.

Transceivers 713 and 723 may each, independently, be a transmitter, a receiver, or both a transmitter and a receiver, or a unit or device that may be configured both for transmission and reception. Further, one or more functionalities may also be implemented as virtual application(s) in software that can run on a server.

Electronic device 710 may be any device with video recording capabilities, such as, but not limited to, for example, a mobile phone or smart phone or multimedia device, a computer, such as a tablet, laptop computer or desktop computer, provided with wireless communication capabilities, personal data or digital assistant (PDA) provided with wireless communication capabilities, cameras, camcorders, unmanned aerial vehicles (UAVs) or remote controlled land and/or air vehicles, and other similar devices. However, some examples, including those shown in FIGS. 1-8, may be implemented on a cloud computing platform or a server 720.

In some embodiments, an apparatus, such as the electronic device 710 or server 720, may include means for carrying out embodiments described above in relation to FIGS. 1-8. In some examples, at least one memory including computer program code can be configured to, with the at least one processor, cause the apparatus at least to perform any of the processes described herein.

Processors 711 and 721 may be embodied by any computational or data processing device, such as a central processing unit (CPU), digital signal processor (DSP), application specific integrated circuit (ASIC), programmable logic device (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 712 and 722 may independently be any suitable storage device such as those described above. The memory and the computer program instructions may be configured, with the processor for the particular device, to cause a hardware apparatus such as user device 710 or server 720, to perform any of the processes described above (see, for example, FIGS. 1-8). Therefore, in some examples, a non-transitory computer-readable medium may be encoded with computer instructions or one or more computer program (such as added or updated software routine, applet or macro) that, when executed in hardware, may perform a process such as one of the processes described herein. Alternatively, some examples may be performed entirely in hardware.

In some examples therefore, it may be possible to provide various commercial benefits. For instance, commercial benefits may be derived by linking various types of data to one or more videos. In some examples, the linked data may include, for example, advertisements, where such advertisements may be directly related or specially tailored to the user. Further, according to other embodiments, it may be possible to compare viewer and video locations to create tailored travel options. In addition, artificial intelligence and/or machine vision linked to data-enabled video may be used to predict commodities futures, highlight infrastructure weaknesses, suggest agricultural changes, and make sense of large sets of big data.

According to other embodiments, it may be possible to provide powerful ways to find and link video content, including objects and/or events within videos, down to their individual frames. It may also be possible to use data to connect videos by finding shared places or events, and to use those connections to create unique insights.

The examples described herein are for illustrative purposes only. As will be appreciated by one skilled in the art, some examples described herein, including, for example, but not limited to, those shown in FIGS. 1-9, may be embodied as a system, apparatus, method, or computer program prod u ct. Accordingly, some examples may take the form of an entirely software embodiment or an embodiment combining software and hardware aspects. Software may include but is not limited to firmware, resident software, or microcode. Furthermore, other embodiments may take the form of a computer program product accessible from a computer-usable or computer- readable medium providing program code for use by or in connection with a computer or any instruction execution system.

Any combination of one or more computer usable or computer readable medium(s) m ay be utilized in some examples described herein. For the purposes of this description, a computer-usable or computer readable medium can be any apparatus that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may independently be any suitable storage device, such as a non-transitory computer-readable medium. Suitable types of memory m ay include, but not limited to: a portable computer diskette; a hard disk drive (HDD), a random-access memory (RAM), a read-only memory (ROM); an erasable programmable read-only memory (EPROM or Flash memory); a portable compact disc read-only memory (CDROM); and/or an optical storage device.

The memory may be combined on a single integrated circuit as a processor or may be separate therefrom. Furthermore, the computer program instructions stored in the memory may be processed by the processor can be any suitable form of computer program code, for example, a compiled or interpreted computer program written in any suitable programming language. The memory or data storage entity is typically internal, but may also be external or a combination thereof, such as in the case when additional memory capacity is obtained from a service provider. The memory may al so be fixed or removable.

The computer usable program code (software) may be transmitted using any appropriate transmission media via any conventional network. Computer program code, when executed in hardware, for carrying out operations of some examples may be written in any combination of one or more programming languages, including, but not limited to, an object-oriented programming language such as Java, Smalltalk, C++, C# or the like and conventional procedural programming languages, such as the “C” programming language or similar programming languages. Alternatively, some examples may be performed entirely in hardware.

Depending upon the specific embodiment, the program code may be executed entirely on a user's device, partly on the user's device, as a stand-alone software package, partly on the user's device and partly on a remote computer, or entirely on the remote computer or server. In the latter scenario, the remote computer may be connected to the user's device through any type of conventional network. This may include, for example, a local area network (LAN) or a wide area network (WAN), Bluetooth, Wi-Fi, satellite, or cellular network, or the connection may be made to an external computer (for example, through the Internet using an Internet Service Provider).

It is to be understood that the foregoing description is intended to illustrate and not to limit the scope of the invention, which is defined by the scope of the appended claims. Other embodiments are within the scope of the following claims.

What is claimed is:

1. An method comprising:
maintaining a representation of a spatial region;
maintaining a plurality of trajectory records, each trajectory record comprising a sequence of time points and corresponding spatial coordinates;
maintaining, for each trajectory record of the plurality of trajectory records, sensor data, the sensor data being synchronized to the sequence of time points and corresponding spatial coordinates. presenting a portion of the representation of the spatial region including
presenting a representation of multiple trajectory records of the plurality of trajectory records, each trajectory record of the multiple trajectory records having at least some spatial coordinates located in the portion of the spatial region.

2. The method of claim 1 further comprising determining the multiple trajectory records based on a query.

3. The method of claim 2 wherein the query includes one or both of spatial query parameters and temporal query parameters.

4. The method of claim 2 wherein the query includes sensor data query parameters.

5. The method of claim 2 wherein the query includes a specification of a second sequence of time points and corresponding spatial coordinates, and the multiple trajectory records intersect with the second sequence of time points and corresponding spatial coordinates.

6. The method of claim 5 wherein intersecting with the second sequence of time points and corresponding spatial coordinates includes collecting sensor data related to the second sequence of time points and corresponding spatial coordinates.

7. The method of claim 5 further comprising receiving a selection of a part of a first line representing the specification of the second sequence of time points and corresponding spatial coordinates and, the part of the first line corresponding to a first time point in the second sequence of time points and corresponding spatial coordinates, the selection causing presentations representations of the sensor data corresponding to the first time point from the multiple trajectory records.

8. The method of claim 7 further comprising receiving an input causing the selection of the part of the first line to move along the first line, the moving causing sequential presentation of the representations of the sensor data corresponding to a plurality of time points adjacent to the first time point in the sequence of time points of the multiple trajectory records.

9. The method of claim 2 wherein the query constrains the multiple trajectory records to trajectory records of the plurality of trajectory records that include spatial coordinates that traverse a first portion of the spatial region.

10. The method of claim 9 wherein the first portion of the spatial region is equivalent to the presented portion of the representation of the spatial region.

11. The method of claim 9 wherein the first portion of the spatial region is a spatial region inside of the presented portion of the representation of the spatial region.

12. The method of claim 1 wherein, for each of the multiple trajectory records, the representation of the trajectory record includes a line tracing a route defined by the trajectory record.

13. The method of claim 12 where the line includes a polyline.

14. The method of claim 12 further comprising receiving a selection of a part of a first line representing a first trajectory record of the multiple trajectory records, the part of the first line corresponding to a first time point in the sequence of time points and corresponding spatial coordinates of the first trajectory, the selection causing presentation of a representation of the sensor data corresponding to the first time point.

15. The method of claim 14 wherein the selection further causes presentation of a representation of sensor data corresponding to the first time point of a second trajectory record of the multiple trajectory records.

16. The method of claim 14 further comprising receiving an input causing the selection of the part of the first line to move along the first line, the moving causing sequential presentation of representations of the sensor data corresponding to a number of time points adjacent to the first time point in the sequence of time points and corresponding spatial coordinates of the first trajectory record.

17. The method of claim 16 wherein the moving further causes sequential presentation of representations of sensor data corresponding to a number of time points adjacent to the first time point in a sequence of times points and corresponding spatial coordinates of a second trajectory record of the multiple trajectory records.

18. The method of claim 1 wherein the spatial coordinates include geospatial coordinates.

19. The method of claim 1 wherein the spatial coordinates include three-dimensional coordinates.

20. The method of claim 1 wherein the sensor data includes camera data.

21. The method of claim 1 wherein the sensor data includes telemetry data.

22. The method of claim 21 wherein the telemetry data includes one or more of temperature data, pressure data, acoustic data, velocity data, acceleration data, fuel reserve data, battery reserve data, altitude data, heading data, orientation data, force data, acceleration data, sensor orientation data, field of view data, zoom data, sensor type data, exposure data, date and time data, electromagnetic data, chemical detection data, and signal strength data.

23. The method of claim 1 further comprising receiving a selection of a representation of a first trajectory record of the multiple trajectory records and, based on the selection, presenting a trajectory record viewer including:
presenting a sensor data display region in the trajectory record viewer for viewing the sensor data according to the sequence of time points of the first trajectory record, the sensor display region including a first control for scrubbing through the sensor data according to the time points of the first trajectory record, and
presenting spatial trajectory display region in the trajectory record viewer for viewing the representation of the first trajectory record in a second portion of the representation of the spatial region, the spatial trajectory display region including a second control for scrubbing through the time points of the first trajectory record according to the spatial coordinates of the first trajectory record.

24. The method of claim 23 wherein movement of the first control to a first time point and corresponding first sensor data point of the first trajectory record causes movement of the second control to the first time point and corresponding first spatial coordinate of the first trajectory record, and movement of the second control to a second spatial coordinate and corresponding second time point of the first trajectory record causes movement of the first control to the second time point and corresponding second sensor data point of the first trajectory record.

25. The method of claim 23 wherein the sensor data of the first trajectory record includes video data and the sensor display region in the trajectory viewer includes a video player.

26. The method of claim 23 further comprising presenting a second sensor data display region in the trajectory record viewer for viewing sensor data according to a sequence of time points of a second trajectory record, the second sensor display region including a third control for scrubbing through the sensor data according to the time points of the second trajectory record, wherein scrubbing the third control causes a corresponding scrubbing of the first control.

27. A video capture and interface system comprising:
an interface system configured to receive information acquired from a moving vehicle, including receiving a plurality of parts of the information with corresponding different delays relative to the time of acquisition at the vehicle;
the interface system including a presentation subsystem for displaying or providing access to the parts of the information as they become available in conjunction with a display of a trajectory of the vehicle.
